(19) United States
(12) Patent Application Publication
(10) Pub. No.: US 2014/0112003 A1
(43) Pub. Date: Apr. 24, 2014

(54) METHODS AND APPARATUS RELATED TO AN OPTICAL LENS FOR A LED

(71) Applicant: Luc Guy Louis Lacroix, Dunstable, MA (US)

(72) Inventor: Luc Guy Louis Lacroix, Dunstable, MA (US)

(73) Assignee: KONINKLIJKE PHILIPS N.V., EINDHOVEN (NL)

(21) Appl. No.: 14/126,863

(22) PCT Filed: Jun. 15, 2012
(86) PCT No.: PCT/IB12/53033

§ 371 Date: Dec. 17, 2013

Related U.S. Application Data
(60) Provisional application No. 61/498,830, filed on Jun. 20, 2011.

(51) Int. Cl. F21K 99/00

(52) U.S. Cl. CPC F21K 9/50
USPC 362/329; 29/592

(57) ABSTRACT

Methods and apparatus for an optical lens (10, 110) suitable to provide an asymmetric light output pattern when utilized in combination with at least one LED. The optical lens (10, 110) may include a revolved section (20, 120) having and an extruded section (40, 140) extending from the end of the revolved section (20, 120). One or more surface features may optionally be applied to portions of the outer surface of the optical lens (10, 110).

### TECHNICAL FIELD

The present invention is directed generally to an optical lens. More particularly, various inventive methods and apparatus disclosed herein relate to an optical lens for use in combination with at least one LED to provide an asymmetric light output pattern.

### BACKGROUND

Digital lighting technologies, i.e. illumination based on semiconductor light sources, such as light-emitting diodes (LEDs), offer a viable alternative to traditional fluorescent, HID, and incandescent lamps. Functional advantages and benefits of LEDs include high energy conversion and optical efficiency, durability, lower operating costs, and many others. Recent advances in LED technology have provided efficient and robust full-spectrum lighting sources that enable a variety of lighting effects in many applications. Some of the fixtures embodying these sources feature a lighting module, including one or more LEDs capable of producing different colors, e.g. red, green, and blue, as well as a processor for independently controlling the output of the LEDs in order to generate a variety of colors and color-changing lighting effects, for example, as discussed in detail in U.S. Pat. Nos. 6,016,038 and 6,211,626.

Many lighting fixtures incorporating one or more LEDs feature one or more optical lenses that are each provided over one or more of the LEDs. For example, some lighting fixtures include a total internal reflection (“TIR”) collimator over one or more LEDs. A TIR collimator includes a reflective inner surface that is positioned about the LED(s) to capture and substantially collimate much of the light emitted thereby. The reflective surface of conventional TIR collimators is typically conical, that is, derived from a parabolic, elliptical, or hyperbolic curve. The reflective surface is configured such that it is sloped to provide an angle of incidence for most of the light rays incident thereon from the LED(s) that is above the critical angle, thereby making the reflective surface reflective via TIR.

The TIR collimators typically include: a first refractive surface that surrounds the light emitting portion of the LED and refracts light rays emitted from the LED; the reflective conical surface surrounding the refractive surface; and an exit surface that is provided atop the reflective conical surface. Light emitted from a LED is refracted trough the first refractive surface of such a collimator, reflected (via TIR) on the reflective conical surface, and then refracted trough the exit surface to thereby produce a substantially collimated light output. Such collimated light output is typically substantially symmetrical, which may be undesirable in certain lighting applications. For example, in lighting applications where a lighting fixture is off center relative to the desired light output target, a symmetrical beam pattern may contain a significant portion of light that misses the desired light output target and/or may non-uniformly illuminate the light output target.

Thus, there is a need in the art to provide an optical lens for use in combination with at least one LED to provide an asymmetric light output pattern.

### SUMMARY

The present disclosure is directed to inventive methods and apparatus for an optical lens utilizable in combination with at least one LED to provide an asymmetric light output pattern. For example, in some embodiments, the optical lens may include a revolved section having an outer conical wall revolved partially about an optical axis of the lens. The optical lens may also include an extruded section that extends from the end of the revolved section along a linear extrusion axis. The extruded section may optionally have a profile as viewed along the linear extrusion axis that substantially conforms to the profile of the end of the outer conical wall at the end of the TIR section. One or more surface features such as cut-outs, protrusions, angled surfaces, prisms, and/or grooves may optionally be applied to portions of the outer surface of the optical lens.

Generally, in one aspect, an asymmetric optical lens is provided that includes a LED recess, an optical axis intersecting the LED recess, and an extrusion axis perpendicular to the optical axis and intersecting the LED recess. The optical lens also includes a revolved section having an outer conical wall revolved partially about the optical axis. The outer conical wall surrounds a portion of the LED recess and is configured to internally reflect and collimate a majority of light output incident thereon originating from the LED recess. The outer conical wall defines a first profile at an end thereof. The optical lens also includes an extruded section extending from the end of the outer conical wall. The extruded section has a profile as viewed along any point of the extrusion axis that substantially conforms to corresponding portions of the first profile.

In some embodiments, the extruded section includes an angled end angled upward and away from the LED recess such that a height of the extruded section along the optical axis decreases as distance from the revolved section along the extrusion axis increases. In some versions of those embodiments the height of the extruded section along the optical axis linearly decreases as distance from the revolved section along the extrusion axis increases.

In some embodiments, the revolved section includes a predefined non-planar upper surface having an optical prescription thereon. In some versions of those embodiments the optical prescription includes at least one groove substantially perpendicular to the optical axis and to the extrusion axis. In some versions of those embodiments the optical prescription includes an upwardly angled surface at an acute angle relative to the optical axis and an obtuse angle relative to the extrusion axis.

Generally, in another aspect, an asymmetric optical lens placeable over at least one LED is provided and includes an optical axis alignable with a light output axis of the LED. The optical lens also includes a revolved section provided approximately one-hundred-and-eighty degrees around the optical axis. The revolved section has an outer conical wall configured to internally reflect and substantially collimate a majority of light output incident thereon from the LED. The outer conical wall defines a first profile at an end of the revolved section. A linear extrusion axis extends perpendicular to the optical axis and perpendicular to the first profile. An extruded section of the optical lens extends from the revolved section and around the remainder of the optical axis. The profile of the extruded section as viewed along any point of the linear extrusion axis substantially conforms to corresponding portions of the first profile.

In some embodiments, the first profile is a best fitting smooth spline.

In some embodiments, the optical lens further includes an inner refractive surface positioned about the optical axis interiorly of the conical wall. The inner refractive surface refracts the light output and directs the light output to the conical wall. In some versions of those embodiments the inner refractive surface includes a convex upper refractive surface. Optionally, the upper refractive surface is a hyperbola having an eccentricity value substantially equal to the refracting index of the material of the optical lens. In some embodiments the optical lens further includes a base extending between the inner refractive surface and the conical wall.

In some embodiments, the entirety of the conical wall is a best fitting smooth spline. Also, the optical axis may be configured for alignment with a central light output axis of the LED.

In some embodiments, the profile of the extruded section along the linear extrusion axis shortens along the optical axis as distance from the revolved section along the linear extrusion axis increases. Also, the revolved section may include a non-planar upper surface having an optical prescription thereon.

Generally, in another aspect, a method of designing an asymmetric optical lens includes the following steps: determining a total internal reflection profile; rotating the total internal reflection profile approximately one hundred and eighty degrees about an optical axis; and linearly extruding the total internal reflection profile from an end of the rotated total internal reflection profile.

The method may further include the steps of undercutting at least a portion of the extruded total internal reflection profile and/or applying a predefined non-planar optical prescription on at least an upper surface of the rotated total internal reflection profile.

In some embodiments, the method further includes the step of determining one or more characteristics of a mounting position of a lighting fixture incorporating the asymmetric optical lens and a desired optical output of the lighting fixture. In some versions of those embodiments, at least one of the total internal reflection profile and the non-planar optical prescription are based on the determining of one or more characteristics of the mounting position and the desired optical output.

As used herein for purposes of the present disclosure, the term “LED” should be understood to include any electroluminescent diode or other type of carrier injection/junction-based system that is capable of generating radiation in response to an electric signal. Thus, the term LED includes, but is not limited to, various semiconductor-based structures that emit light in response to current, light emitting polymers, organic light emitting diodes (OLEDs), electroluminescent strips, and the like. In particular, the term LED refers to light emitting diodes of all types (including semi-conductor and organic light emitting diodes) that may be configured to generate radiation in one or more of the infrared spectrum, ultraviolet spectrum, and various portions of the visible spectrum (generally including radiation wavelengths from approximately 400 nanometers to approximately 700 nanometers). Some examples of LEDs include, but are not limited to, various types of infrared LEDs, ultraviolet LEDs, red LEDs, blue LEDs, green LEDs, yellow LEDs, amber LEDs, orange LEDs, and white LEDs (discussed further below). It also should be appreciated that LEDs may be configured and/or controlled to generate radiation having various bandwidths (e.g., full widths at half maximum, or FWHM) for a given spectrum (e.g., narrow bandwidth, broad bandwidth), and a variety of dominant wavelengths within a given general color categorization.

For example, one implementation of an LED configured to generate essentially white light (e.g., a white LED) may include a number of dies which respectively emit different spectra of electroluminescence that, in combination, mix to form essentially white light. In another implementation, a white light LED may be associated with a phosphor material that converts electroluminescence having a first spectrum to a different second spectrum. In one example of this implementation, electroluminescence having a relatively short wavelength and narrow bandwidth spectrum “pumps” the phosphor material, which in turn radiates longer wavelength radiation having a somewhat broader spectrum.

It should also be understood that the term LED does not limit the physical and/or electrical package type of an LED. For example, as discussed above, an LED may refer to a single light emitting device having multiple dies that are configured to respectively emit different spectra of radiation (e.g., that may or may not be individually controllable). Also, an LED may be associated with a phosphor that is considered as an integral part of the LED (e.g., some types of white LEDs). In general, the term LED may refer to packaged LEDs, non-packaged LEDs, surface mount LEDs, chip-on-board LEDs, T-package mount LEDs, radial package LEDs, power package LEDs, LEDs including some type of encasement and/or optical element (e.g., a diffusing lens), etc.

The term “light source” should be understood to refer to any one or more of a variety of radiation sources, including, but not limited to, LED-based sources (including one or more LEDs as defined above), incandescent sources (e.g., filament lamps, halogen lamps), fluorescent sources, phosphorescent sources, high-intensity discharge sources (e.g., sodium vapor, mercury vapor, and metal halide lamps), lasers, other types of electroluminescent sources, pyro-luminescent sources (e.g., flames), candle-luminescent sources (e.g., gas mantles, carbon arc radiation sources), photo-luminescent sources (e.g., gaseous discharge sources), cathode luminescent sources using electronic satiation, galvano-luminescent sources, crystallo-luminescent sources, kine-luminescent sources, thermo-luminescent sources, triboluminescent sources, sonoluminescent sources, radioluminescent sources, and luminescent polymers.

The term “lighting fixture” is used herein to refer to an implementation or arrangement of one or more lighting units in a particular form factor, assembly, or package. The term “lighting unit” is used herein to refer to an apparatus including one or more light sources of same or different types. A given lighting unit may have any one of a variety of mounting arrangements for the light source(s), enclosure/housing arrangements and shapes, and/or electrical and mechanical connection configurations. Additionally, a given lighting unit optionally may be associated with (e.g., include, be coupled to and/or packaged together with) various other components (e.g., control circuitry) relating to the operation of the light source(s). An “LED-based lighting unit” refers to a lighting unit that includes one or more LED-based light sources as discussed above, alone or in combination with other non LED-based light sources. A “multi-channel” lighting unit refers to an LED-based or non LED-based lighting unit that includes at least two light sources configured to respectively generate different spectrums of radiation, wherein each different source spectrum may be referred to as a “channel” of the multi-channel lighting unit.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 illustrates an upper perspective view of an embodiment of an optical lens.

FIG. 2 illustrates a lower perspective view of the optical lens of FIG. 1.

FIG. 3 illustrates a section view of the optical lens of FIG. 1 taken along the section line 3-3 of FIG. 1 and showing the revolved section of the optical lens.

FIG. 4 illustrates a section view of the optical lens of FIG. 1 taken along the section line 4-4 of FIG. 1 and showing the extruded section of the optical lens.

FIG. 5 illustrates a section view of the optical lens of FIG. 1 taken along the section line 5-5 of FIG. 1.

FIG. 6 illustrates a revolved portion of a second embodiment of an optical lens.

FIG. 7 illustrates the revolved portion and an extruded portion of the second embodiment of the optical lens of FIG. 6; an end of the revolved portion is illustrated in phantom.

FIG. 8 illustrates a LED-based lighting fixture that may incorporate the optical lens; the LED-based lighting fixture is illustrated adjacent a surface.

### DETAILED DESCRIPTION

Many lighting fixtures incorporating one or more LEDs feature one or more optical lenses that are each provided over one or more of the LEDs. For example, some lighting fixtures include a TIR collimator over one or more LEDs to thereby produce a substantially collimated light output. Such collimated light output is typically substantially symmetrical, which may be undesirable in certain lighting applications. For example, in lighting applications where a lighting fixture is off center relative to the desired light output target, a symmetrical beam pattern may contain a significant portion of light that misses the desired light output target and/or may non-uniformly illuminate the light output target.

Thus, Applicant has recognized and appreciated a need in the art to provide an optical lens having a revolved section and an extruded section for use in combination with at least one LED to provide an asymmetric light output pattern. More generally, Applicant has recognized and appreciated that it would be beneficial to have an optical lens for use in combination with at least one LED to provide an asymmetric light output pattern.

In view of the foregoing, various embodiments and implementations of the present invention are directed to an optical lens.

In the following detailed description, for purposes of explanation and not limitation, representative embodiments disclosing specific details are set forth in order to provide a thorough understanding of the claimed invention. However, it will be apparent to one having ordinary skill in the art having had the benefit of the present disclosure that other embodiments according to the present teachings that depart from the specific details disclosed herein remain within the scope of the appended claims. Moreover, descriptions of well-known apparatuses and methods may be omitted so as to not obscure the description of the representative embodiments. Such methods and apparatuses are clearly within the scope of the claimed invention. For example, it is discussed that various embodiments of the optical lens disclosed herein may be utilized in combination with wall wash recess lighting fixture to provide substantially uniform illumination to a target illumination area. However, other LED-based lighting fixtures incorporating the optical lens are contemplated without deviating from the scope or spirit of the claimed invention. For example, an optical lens may be implemented in other LED-based lighting fixtures where an asymmetric light output from one or more LEDs is desired. Such lighting fixtures may optionally provide substantially uniform illumination to a target illumination area or may provide non-uniform illumination thereto.

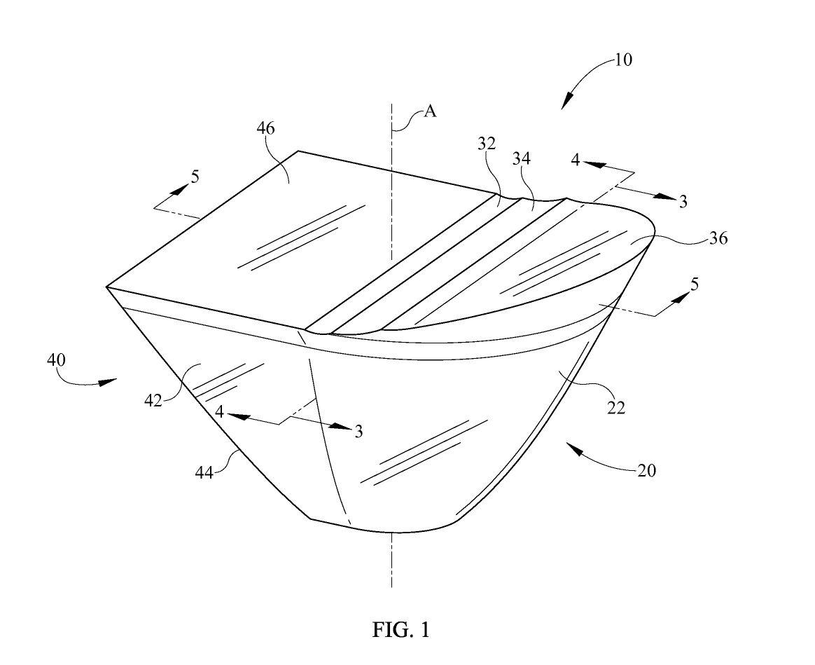

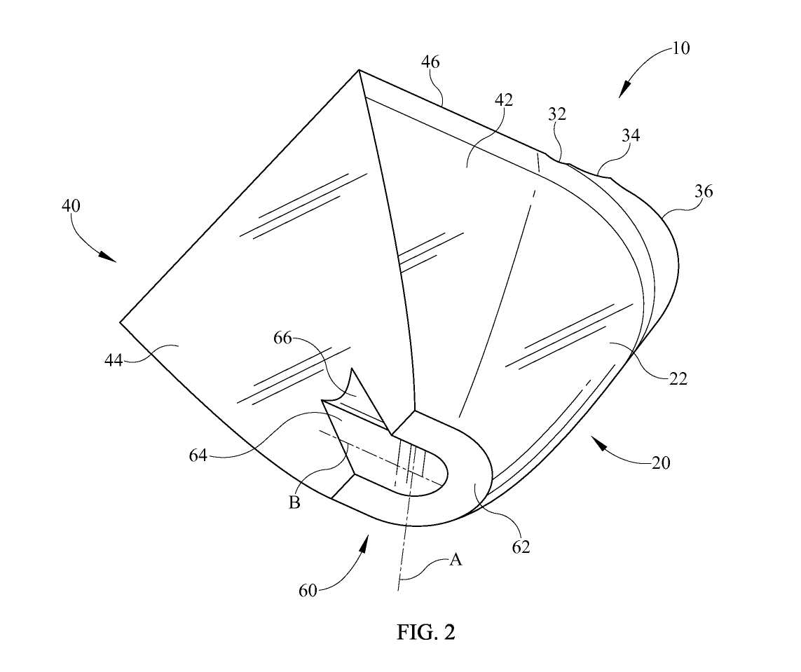

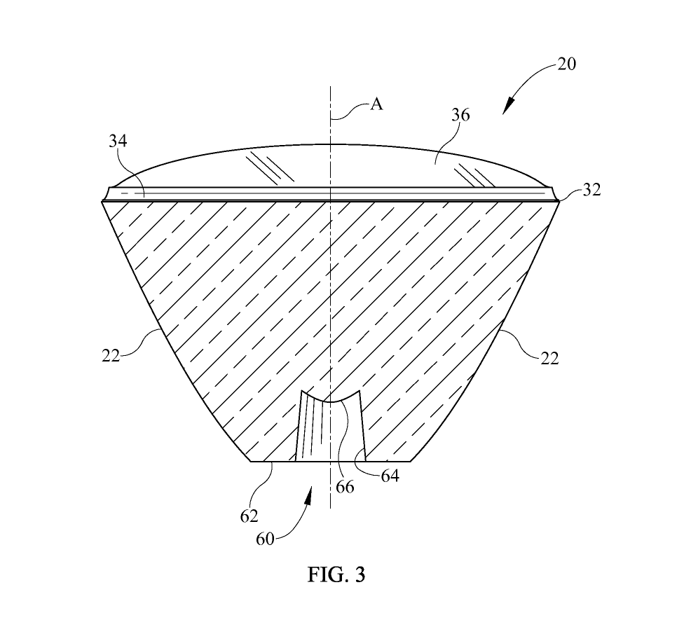

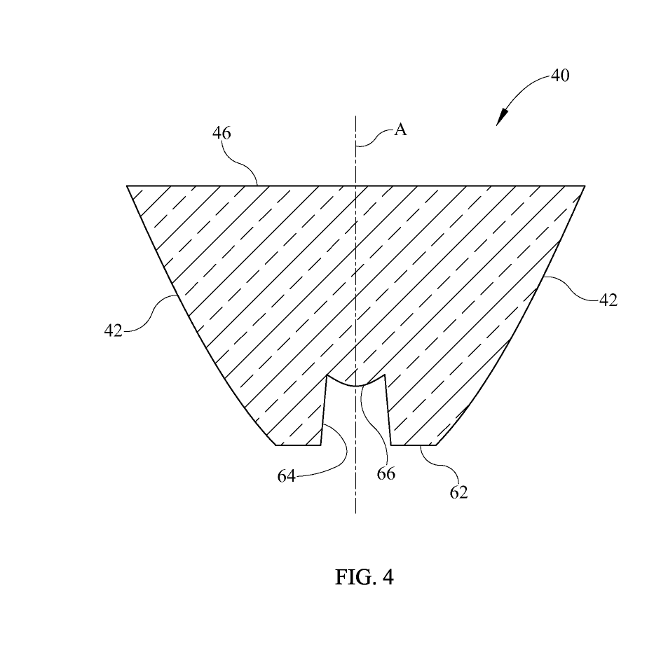

Referring to FIGS. 1 through 5, a first embodiment of an asymmetric optical lens 10 is illustrated. FIGS. 1 and 2 illustrate upper and lower perspective views, respectively, of the optical lens 10. FIGS. 3, 4, and 5 illustrate section views of the optical lens 10 taken along the section lines 3-3, 4-4, and 5-5 of FIG. 1, respectively.

The optical lens 10 includes a revolved section 20 positioned on a first side of an optical axis A and extending approximately one hundred and eighty degrees about the optical axis A. The optical lens 10 also includes an extruded section 40 positioned on a second side of the optical axis A and extending approximately one hundred and eighty degrees thereabout. Generally speaking, the revolved section 20 substantially collimates light rays incident therein in both directions when the optical lens 10 is placed about an LED and the extruded section 40 substantially collimates light rays incident therein in one direction when the optical lens 10 is placed about an LED. In alternative embodiments the sections 20, 40 may each extend more or fewer degrees about the optical axis. For example, in some embodiments revolved section 20 may extend approximately one-hundred-and-ninety degrees around the optical axis A and extruded section 40 may extend approximately one-hundred-and-seventy degrees around the optical axis A.

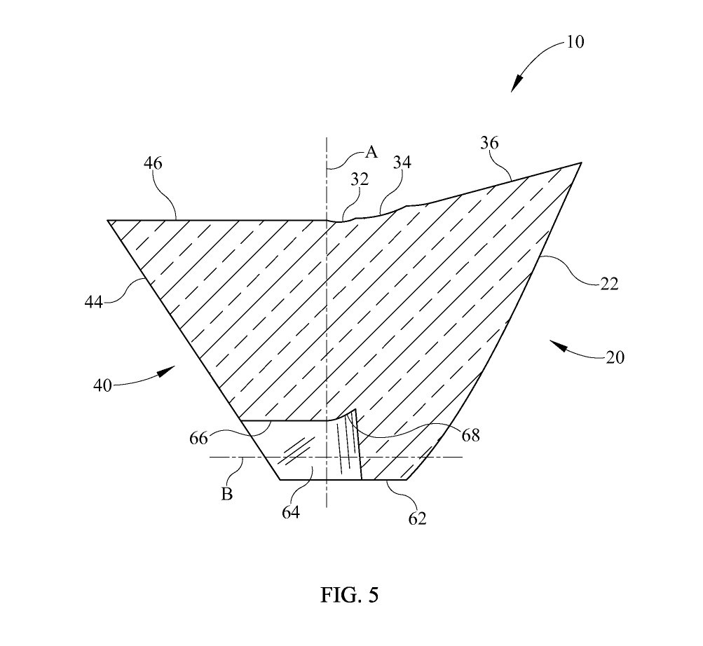

The revolved section 20 includes a TIR conical wall 22. The TIR conical wall 22 is configured to internally reflect a majority of light incident thereon that is emitted from one or more LEDs that the optical lens 10 is positioned about. The illustrated TIR conical wall 22 has a conical best fitting smooth spline profile to optimally reflect (via TIR) and collimate the light refracted by side refractive surface 64. Optionally, the smooth spline may remain substantially constant around the entirety of the TIR conical wall 22. For example, the left and right sides of the profile of the conical wall 22 visible in FIG. 3 are the same. Also, for example, the profile of the conical wall 22 in FIG. 5 is substantially the same as those in FIG. 3, but it extends upward more than the conical walls 22 in FIG. 3. In alternative embodiments the profile of the TIR conical wall 22 may be derived from, for example, another spline profile, a parabolic curve, an elliptical curve, and/or a hyperbolic curve. The profile of the TIR conical wall 22 may optionally be variable in some alternative embodiments as it is revolved around optical axis A. One of ordinary skill in the art having had the benefit of the present disclosure will be able to determine a desired TIR conical wall profile based on, inter alia, one or more of a desired light output from optical lens 10, light output characteristics of one or more LEDs, the index of refraction of the material of the optical lens 10, and/or characteristics of one or more refractive surfaces of the optical lens 10 interior of the TIR conical wall 22.

Extending from the revolved section 20 is an extruded section 40. The extruded section 40 extends linearly from the revolved section 20 along a linear extrusion axis B (FIGS. 2 and 5) that extends generally perpendicular to the optical axis A. The illustrated extruded section 40 is a linear extrusion of the end of the revolved section 20 along the linear extrusion axis B. The extruded section 40 includes extruded sides 42 each having a profile that corresponds to the profile of a corresponding portion of the TIR conical wall 22 at an end of the revolved section 20 (e.g., the profile as viewed in FIG. 3). The extruded section 40 also includes a substantially planar upper surface 46 and an extruded angled end 44. The angled end 44 represents an angled cutout of the linear extrusion and may help minimize artifact lights. In alternative embodiments the end of the linear extrusion section 40 may be cutout at a different angle, may be cutout at a non-planar angle, may not be cutout at an angle, and/or may be cutout at an angle along only a portion thereof.

Located interiorly of the TIR conical wall 22 and the extruded side 42 is a LED recess 60 having a side refractive surface 64 and an upper refractive surface 66. The LED recess 60 is sized to house at least the light emitting portion of one or more LEDs therein. For example, the LED recess 60 may be sized to house the entirety of a single surface mount LED package. The upper refractive surface 66 is convex relative to the LED recess 60 and includes a raised portion 68 as it moves toward the periphery of the upper refractive surface 66 in the revolved section 20. The upper refractive surface 66 is substantially tubular along extruded section 40 and is substantially spherical along revolved section 20. In some embodiments the refractive surface 66 may be a hyperbola with an eccentricity value equal to the refracting index of the material of the optical lens 10. In such embodiments light rays that are emitted from a LED at the lower focus of the refractive surface 66, and are incident on the refractive surface 66, will enter the optical lens 10 parallel to the transverse axis of the hyperbola.

The side refractive surface 64 is substantially U-shaped, having an open end through angled end 44. In other embodiments the LED recess 60 may not include the open end through angled end 44. Extending between the side refractive surface 64 and the exterior surface of the optical lens 10 is a substantially U-shaped base 62.

The LED recess 60 may receive one or more LEDs therein. A single LED may optionally be received in the LED recess 60 such that a central light output axis thereof is substantially aligned with the optical axis A. The central light output axis of a LED generally corresponds to the center of the light emitting portion thereof and may generally correspond to the central portion of the light distribution of the LED. In alternative embodiments a LED may be positioned within the recess such that the central light output axis of the LED is offset and/or at a non-parallel angle relative to the optical axis A.

Generally speaking, the refractive surfaces 64 and 66 refract light emitted by a LED located interiorly thereof and direct such light toward the exterior surfaces of the optical lens 10. The refractive surfaces 64 and 66 may optionally be configured to interact with a particular LED or group of LEDs. Although particular refractive surfaces 64 and 66 are illustrated and described herein, one of ordinary skill in the art having had the benefit of the present disclosure will recognize that in alternative embodiments alternative refractive surfaces 64 and 66 may be utilized to achieve a desired light distribution and/or to interface with alternative configurations of optical lens 10. Also, although a base 62 is illustrated that may be placed about a mounting surface and/or a substrate on which a LED is mounted, in alternative embodiments the optical lens 10 may be otherwise placed about and/or receive light output from one or more LEDs.

The upper surface of the revolved section 20 extending between the upper extents of the TIR conical wall 22 is non-planar in the illustrated embodiment and has a custom optical prescription thereon. The custom optical prescription includes a first groove 32 extending across the upper surface in a direction substantially perpendicular to the optical axis A and substantially perpendicular to the linear extrusion axis B. As illustrated in FIGS. 1 and 5, the groove 32 is recessed below a plane generally defined by the extruded upper surface 46. The optical prescription also includes a second groove 34 extending across the upper surface in a direction substantially perpendicular to the optical axis A and substantially perpendicular to the linear extrusion axis B. As illustrated in FIGS. 1 and 5, the groove 34 is raised above a plane generally defined by the extruded upper surface 46. Moreover, the groove 34 slopes upward as it moves farther from first groove 32. In other words, the longitudinal edge of the groove 34 that is most distal the optical axis A is disposed more distal from the base 62 (in a direction along axis A) than the longitudinal edge of the groove 34 that is most proximal the optical axis A is from the base 62.

The optical prescription also includes an angled upper surface 36 that extends upward as it moves farther from optical axis A and farther from grooves 32 and 34. The angled upper surface 36 is substantially planar in the illustrated embodiment. In alternative embodiments the angled upper surface 36 may be concave, convex, have discontinuities thereacross, or otherwise be non-planar. The TIR conical wall 22 extends up uninterrupted to the angled upper surface 36 and the grooves 32 and 34. In alternative embodiments the exterior side wall between the upper surface of all or portions of any optical prescription and the TIR conical wall 22 may be distinct from adjoining portions of the TIR conical wall 22. For example, in some embodiments all or portions of such exterior side wall may protrude and/or be recessed relative to portions of the TIR conical wall 22.

Generally speaking, the grooves 32 and 34 generally divert at least some of the light output incident thereon therearound. For example, the groove 32 may divert light output incident thereon substantially equally between a direction generally toward extents of extruded section 40 and a direction generally toward extents of revolved section 20. Also, for example, the groove 34 may divert most light output incident thereon in a direction away from extruded section 40. Generally speaking, the angled upper surface 36 widens the beam of light output incident thereon in a direction along the linear extension axis B.

Although a particular optical prescription is illustrated and described herein, one of ordinary skill in the art having had the benefit of the present disclosure will recognize that in alternative embodiments alternative optical prescriptions may be utilized to achieve a desired light distribution. Such optical prescriptions may be applied on the upper surface of the revolved section 20 and/or the extruded section 40. One or more surface manipulations may be utilized in achieving a desired optical prescription. For example, one or more of texturing, fluting, pillows, ridges, cutouts, grooves, and/or prisms may be applied to and/or integrally formed with the upper surface of the optical lens 10 to achieve a desired light output distribution.

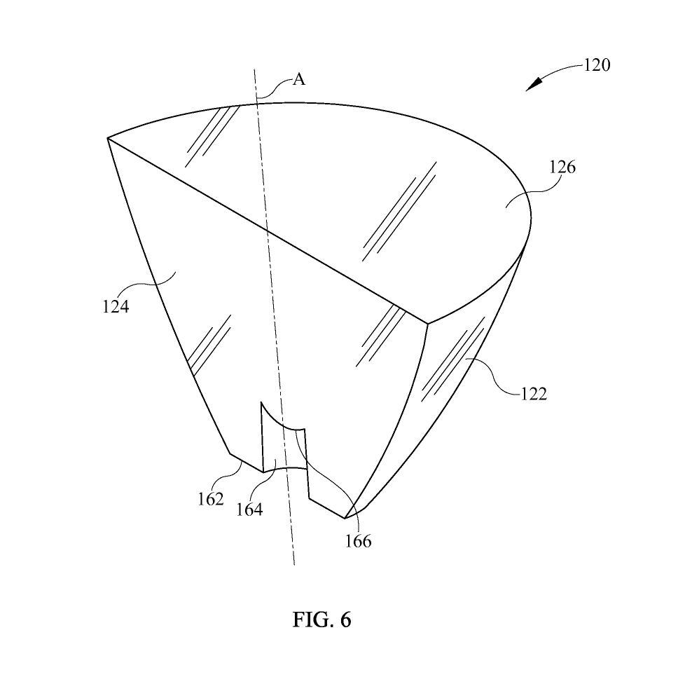

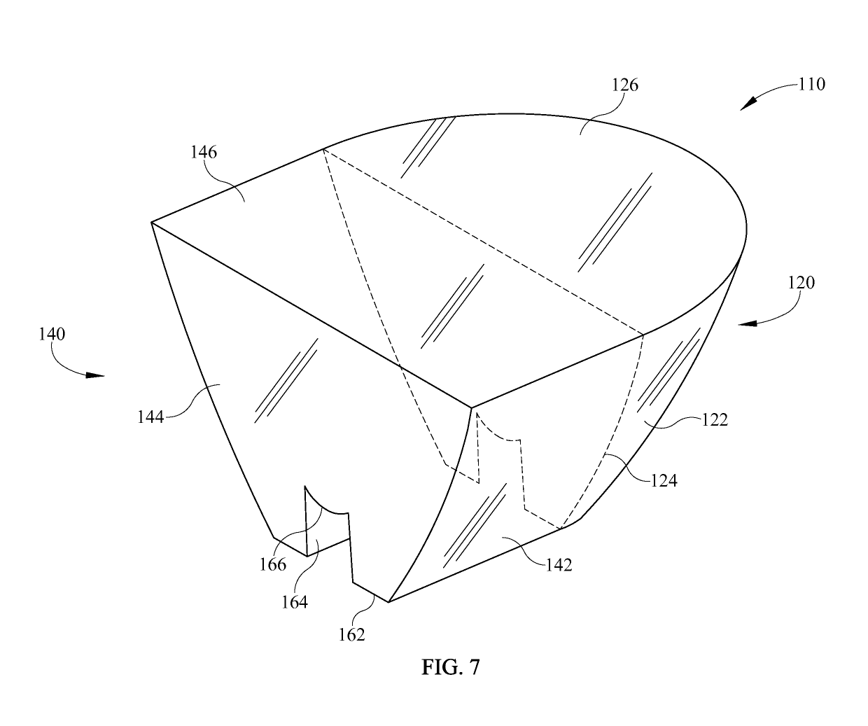

Referring now to FIGS. 6 and 7, a second embodiment of an optical lens 110 is illustrated. FIG. 6 illustrates a revolved portion 120 of the second embodiment of the optical lens 110. The revolved portion 120 extends approximately one-hundred-and-eighty degrees around the optical axis A and may be created by revolving a conical profile about the optical axis A. The revolved portion 120 has a TIR conical wall 122 with an end 124 thereof being illustrated in FIG. 6. The revolved upper surface 126 is substantially planar and does not have any additional optical prescription applied thereto. A curved portion of the side refractive surface 164 and a spherical portion of the upper refractive surface 166 are also illustrated in FIG. 6.

FIG. 7 illustrates the extruded portion 140 in combination with the revolved portion 120. The end 124 of the extruded portion is depicted in phantom lines. The extruded portion 140 includes a non-angled end 144 and an extruded upper surface 146 that is substantially planar and does not have any additional optical prescription applied thereto. In alternative embodiments all or portions of the non-angled end 144 may be provided with a cut-out. Also, in alternative embodiments an optical prescription may be applied to all or portions of revolved upper surface 126 and/or extruded upper surface 146.

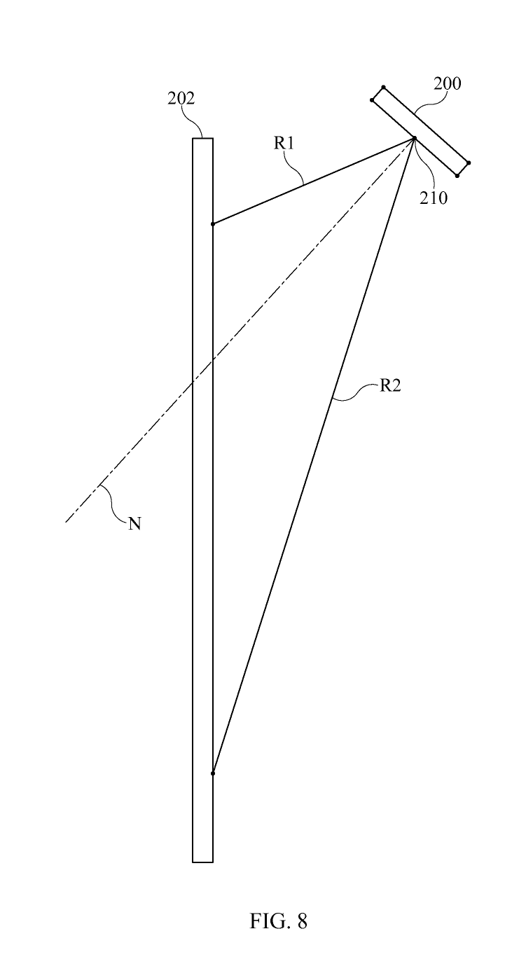

FIG. 8 illustrates a LED-based lighting fixture 200 that may incorporate the optical lens 10 and/or 110. The LED-based lighting fixture 200 is illustrated adjacent a surface 202 and emitting a light output 210. The LED-based lighting fixture 200 may optionally be a recessed wall wash lighting fixture. Axis N represents an axis that is generally normal to the LED-based light source of the LED-based lighting fixture 200. Light rays R1 and R2 are exemplary LED light rays that are each angularly offset from the axis N by the same amount in opposite directions.

If a symmetrical optical lens was utilized with the LED(s) of the lighting fixture 200, then the light rays R1 and R2 would have substantially the same luminous intensity. However, the section of the surface 202 receiving ray R1 would be illuminated moreso than the section of surface 202 receiving ray R2 since ray R2 must travel a greater distance to reach such section. Accordingly, it may be desirable in such an application to provide an asymmetric optical lens as described herein. A designer may optionally choose particular optical characteristics of such an optical lens to create a substantially uniform illumination on the wall target 10. For example, the designer may choose optical characteristics that increase the luminous intensity of ray R2 and that decrease the intensity of ray R1 so that illumination of each section of the wall upon which the rays are incident is more uniform. For example, light output from the revolved section of an optical lens may be of greater luminous intensity and directed toward sections of the surface 202 that are further from the lighting fixture 200 and light output from the extruded section of an optical lens may be of lesser luminous intensity and directed toward sections of surface 202 that are closer to lighting fixture 200.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

It should also be understood that, unless clearly indicated to the contrary, in any methods claimed herein that include more than one step or act, the order of the steps or acts of the method is not necessarily limited to the order in which the steps or acts of the method are recited. Also, all reference numerals appearing in the claims in parentheses are merely for convenience and should not be viewed as limiting in any way.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

What is claimed is:

1. An asymmetric optical lens, comprising:
a LED recess;
an optical axis intersecting said LED recess;
an extrusion axis perpendicular to said optical axis and intersecting said LED recess;
a revolved section having an outer conical wall revolved partially about said optical axis, said outer conical wall surrounding a portion of said LED recess and configured to internally reflect and collimate a majority of light output incident thereon originating from said LED recess;
wherein said outer conical wall form first and second sides which defines a first profile about said a optical axis A at an end thereof;
an extruded section extending from said end of said outer conical wall including extruded sides and each having a profile as viewed along any point of said extrusion axis that substantially conforms to corresponding portions of said first and second sides of said outer conical wall forming said first profile.

2. The lens of claim 1, wherein said extruded section includes an angled end angled upward and away from said LED recess such that a height of said extruded section along said optical axis decreases as distance from said revolved section along said extrusion axis increases.

3. The lens of claim 2, wherein said height of said extruded section along said optical axis linearly decreases as distance from said revolved section along said extrusion axis increases.

4. The lens of claim 1, wherein said revolved section includes a predefined non-planar upper surface having an optical prescription thereon.

5. The lens of claim 4, wherein said optical prescription includes at least one groove substantially perpendicular to said optical axis and to said extrusion axis.

6. The lens of claim 4, wherein said optical prescription includes an upwardly angled surface at an acute angle relative to said optical axis and an obtuse angle relative to said extrusion axis.

7. The lens of claim 6, wherein said optical prescription includes at least one groove interposed between said optical axis and said upwardly angled surface.

8. An asymmetric optical lens placeable over at least one LED, comprising:
an optical axis alignable with a light output axis of said LED;
a revolved section provided approximately one-hundred-and-eighty degrees around said optical axis, said revolved section having an outer conical wall configured to internally reflect and substantially collimate a majority of light output incident thereon from said LED;
wherein said outer conical wall defines a first profile at an end of said revolved section;
a linear extrusion axis extending perpendicular to said optical axis and perpendicular to said first profile;
an extruded section extending from said revolved section and around the remainder of said optical axis;
wherein the profile of said extruded section as viewed along any point of said linear extrusion axis substantially conforms to corresponding portions of said first profile.

9. The lens of aim 8, wherein said first profile is a best fitting smooth spline.

10. The lens of claim 8, further comprising an inner refractive surface positioned about said optical axis interiorly of said conical wall, said inner refractive surface refracting said light output and directing said light output to said conical wall.

11. The lens of claim 10, wherein said inner refractive surface includes a convex upper refractive surface.

12. The lens of claim 10, further comprising a base extending between said inner refractive surface and said conical wall.

13. The lens of claim 8, wherein the entirety of said conical wall is a best fitting smooth spline.

14. The lens of claim 8, wherein said optical axis is configured for alignment with a central said light output axis of said LED.

15. The lens of claim 8, wherein the profile of said extruded section along said linear extrusion axis shortens along said optical axis as distance from said revolved section along said linear extrusion axis increases.

16. The lens of claim 8, wherein said revolved section includes a non-planar upper surface having an optical prescription thereon.

17. A method of designing an asymmetric optical lens, comprising:
determining a total internal reflection profile;
rotating said total internal reflection profile approximately one hundred and eighty degrees about an optical axis;
linearly extruding said total internal reflection profile from an end of said rotated total internal reflection profile;
undercutting at least a portion of said extruded total internal reflection profile; and
applying a predefined non-planar optical prescription on at least an upper surface of said rotated total internal reflection profile.

18. The method of claim 16, further comprising determining one or more characteristics of a mounting position of a lighting fixture incorporating said asymmetric optical lens and a desired optical output of said lighting fixture.

19. The method of claim 18, wherein at least one of said total internal refection profile and said non-planar optical prescription are based on said determining of one or more characteristics of said mounting position and said desired optical output.

20. The method of claim 18, wherein both of said total internal reflection profile and said non-planar optical prescription are based on said determining of one or more characteristics of said mounting position and said desired optical output.
